(19) United States
(12) Patent Application Publication
(10) Pub. No.: US 2012/0074676 A1
(43) Pub. Date: Mar. 29, 2012

(54) AIRBAG MODULE FOR A MOTOR VEHICLE

(75) Inventor: Jens Feller, Illerkirchberg (DE)

(73) Assignee: TAKATA-PETRI AG

(21) Appl. No.: 13/307,896

(22) Filed: Nov. 30, 2011

Related U.S. Application Data
(63) Continuation of application No. PCT/EP2010/057724, filed on Jun. 2, 2010.

(30) Foreign Application Priority Data
Jun. 4, 2009 (DE) 10 2009 024 142.6

(51) Int. Cl. B60R 21/16

(52) U.S. Cl. 280/730.2

(57) ABSTRACT

An airbag module, in particular side airbag module, for a motor vehicle, is provided. The airbag module comprising a gas bag inflatable with gas to protect a person, a gas generator longitudinally extending along a direction of extension for releasing the gas required for inflating the gas bag, and a flat carrier for carrying the gas bag and the gas generator, wherein the carrier includes two legs which are connected with each other along the direction of extension and are located opposite each other transverse to the direction of extension, so that the carrier forms a receptacle open on three sides for the gas generator and the gas bag. The carrier comprises a flow-off region, through which gas emerging from at least one outflow opening of the gas generator can be flown off into an exterior space surrounding the airbag module.

### CROSS-REFERENCE TO RELATED PATENT APPLICATIONS

This application is a continuation of International Patent Application Number PCT/EP 2010/057724, filed on Jun. 2, 2010, which published in German as WO 2010/139735. The foregoing international application is incorporated by reference herein.

### BACKGROUND OF THE INVENTION

This invention relates to an airbag module for a motor vehicle, in particular to a side airbag module.

Such airbag module includes a gas bag inflatable with gas to protect a person, a gas generator which can be formed to extend along a direction of extension and serves for releasing the gas required for inflating the gas bag, and a rigid carrier for carrying the gas bag and the gas generator.

### SUMMARY OF THE INVENTION

It is an object of the invention to improve such airbag module with regard to the deployment speed of the gas bag and its guidance during deployment, while at the same time requiring a small amount of components.

According to an exemplary embodiment of the invention it is provided that an airbag module includes a flat, possibly curved, in particular rigid (possibly deformable) carrier for carrying the gas bag and the gas generator, wherein the carrier includes two legs which are connected with each other along the direction of extension along which the gas generator extends and are located opposite each other transverse to the direction of extension—or in other words, the carrier is formed U-shaped in cross-section—, so that the carrier forms a receptacle open on three sides for the gas generator and the gas bag, wherein the carrier together with the components fixed thereon can be surrounded by a protective sleeve which in particular covers said open sides. Receptacle for the gas bag in particular means that the part of the gas bag folded up to form a gas bag package (convolution) is arranged in that receptacle, wherein of course portions of the gas bag can be arranged outside that receptacle (already before inflation), for example when the carrier is arranged in an interior space of the gas bag or the like.

In one exemplary embodiment, the legs are integrally molded to each other along the direction of extension, wherein the two legs can be formed mirror-symmetrically. Such carrier for example can be formed from a flat plate (e.g. from a metal), which is bent along a bending line, so that the opposed legs are obtained. It is also possible to mold the carrier from a plastic material, for example by injection molding. Suitable materials include plastic materials such as e.g. Sarlink™ or Thermorun™.

For the protection of the carrier and above all the gas bag, a flexible protective sleeve of the airbag module can be provided, which closely surrounds the carrier, the gas generator and the gas bag, before inflating the gas bag. The protective sleeve can be formed by at least two protective sleeve parts, which are welded or bonded to each other to form the protective sleeve. It is also possible to provide a protective sleeve of a rigid plastic material, wherein parts of that protective sleeve then can be connected with each other by means of one or more clip closures.

In one exemplary design variant of the invention, the carrier is introduced into a pocket formed at the gas bag for fixing the gas bag on the carrier, which pocket forms a receptacle for the carrier. This pocket in particular is a pocket formed in addition to an interior space of the gas bag. Such pocket is at least closed on two (opposite) sides and correspondingly has at least one opening through which the carrier can be introduced into the pocket. Such pocket can be formed for example by applying a flexible material layer onto a gas bag envelope surrounding the interior space of the gas bag to be filled with gas. In this case, one side of that pocket is formed by the gas bag (gas bag envelope) and the other side is formed by the applied material region. In particular, that material layer can be a region of the protective sleeve, which in this case is connected with the gas bag or its gas bag envelope such that the protective sleeve together with the gas bag or the gas bag envelope forms said pocket for the carrier. In one region, for example, the protective sleeve therefore can be connected with the gas bag (gas bag envelope) by means of two parallel seams, so that between those two seams the pocket is formed. It can of course also be a U-shaped seam contour, so that the pocket only is open towards one side. Furthermore, a material layer can circumferentially be connected with the gas bag (gas bag envelope). In this case, a possibly slot-shaped opening preferably is provided at that material layer or the gas bag or gas bag envelope, through which the carrier can be introduced into the pocket.

In an alternative exemplary embodiment of the invention, the carrier is connected with the gas bag (gas bag envelope) via a seam for fixing the gas bag on the carrier, which seam at least partly extends along an outer circumferential edge of the carrier. In particular, that seam connecting the carrier with the gas bag also can extend along said edge. Sewing the gas bag to the carrier material directly (immediately) or, in the case of non-sewable carriers, fixing the carrier with the airbag by cut-out regions in the carrier material also is conceivable, wherein sewing then can be effected inside these regions. Thus, the carrier for example can include one or more continuous cut-outs within which opposed gas bag parts can be sewn to each other or can be connected with each other in some other way.

Instead of a seam connection, the carrier can also be welded or bonded to the gas bag for fixing the gas bag on the carrier, wherein such bond/weld can extend partly or circumferentially along said outer edge of the carrier. It is, however, also possible that the carrier is fully bonded (connected) to the gas bag.

Furthermore, the gas bag defines the interior space mentioned already, which can be filled with gas for inflating the gas bag, or in other words the gas bag envelope of the gas bag surrounds the interior space of the gas bag to be filled with gas for inflating the gas bag. In the present case, the term gas bag envelope thus serves for a more detailed description of the gas bag, which beside the actual gas bag envelope, which surrounds the interior space of the gas bag to be filled with gas, can include further components.

The carrier preferably is arranged outside the interior space and connected there with the gas bag envelope (e.g. by arranging the carrier in said pocket or by the described sewing, welding or bonding of the carrier with the gas bag envelope of the gas bag). It is, however, also conceivable to arrange the carrier in the interior space of the gas bag and fix the same on the gas bag envelope from the interior space in one of the ways described already (in this case, the pocket cannot be formed by an external protective sleeve). In particular, the carrier can be glued into the gas bag.

Furthermore, the carrier preferably also serves for fixing the airbag module on a motor vehicle part, in particular on a motor vehicle seat. For this purpose, the carrier preferably includes a fastening means which can include a hook (tabs) and/or a through hole. By means of such hook, the airbag module for example can be hooked into the frame of a backrest of the motor vehicle seat, wherein for finally fixing the airbag module on the frame e.g. a screw (bolt) can be used, which extends through said through hole and for example is screwed into the backrest frame or secured there with a nut.

Via the carrier, in particular the gas generator also is fixed on the airbag module, wherein in this case the gas generator preferably includes at least one bolt protruding from the gas generator, wherein that at least one bolt extends through an associated through hole of the carrier and can be screwed to the carrier by means of a nut. For this purpose, that at least one bolt also extends through a corresponding through opening of the gas bag envelope and possibly of the protective sleeve.

The two legs of the carrier in particular form an ejection channel or a guideway for the gas bag during deployment of the gas bag. For this purpose, the two legs (except in the region of their connection) preferably extend parallel to each other, wherein in a side airbag module—based on a proper mounting condition of the side airbag module—they each extend along the x-z-plane which is defined by the longitudinal axis x of the vehicle and the vertical vehicle axis z. In this case, the gas bag is formed to extend flat along said x-z-plane in its unfolded condition.

The two legs of the carrier can of course also include other angles. Furthermore, the legs can be formed such that they are pressed apart during deployment of the gas bag (by filling the gas bag with gas). In this case the legs thus have a starting position, in which the two legs are aligned for example parallel to each other as described above (i.e. form an angle of 0°), and an end position in which the legs are arranged pressed apart due to the deployment of the gas bag and hence diverge (i.e. form an angle greater than 0°). During deployment of the gas bag, the carrier thus can be deformed inelastically.

Preferably, the gas bag is folded to a package arranged between the legs, wherein that package also referred to as convolution in particular includes an indentation of the gas bag towards the gas generator.

In one exemplary variant of the invention it is provided that for fixing that convolution regions of the gas bag are connected with each other by means of a tear seam, wherein that tear seam in particular can be formed circumferentially. Alternatively or in addition, regions of the gas bag or the gas bag envelope and possibly of the protective sleeve also can be connected with each other via closure strips sewn to those regions for fixing said convolution, wherein those closure strips in particular can be bonded or welded to each other, wherein those bonds or welds each can form predetermined breaking points which provide for a controlled separation of initially connected closure strips during deployment of the gas bag. The closure strips can of course also form hook or eyelet regions (or the like) of a hook-and-loop fastener.

Furthermore, an outflow mechanism preferably is provided in an airbag module according to the invention, by means of which gas present in the gas bag can be flown off.

For this purpose, a flow-off region preferably is provided at the carrier, via which gas flowing out from at least one outflow opening of the gas generator can be flown off into an external space surrounding the airbag module, wherein in particular that flow-off region is located opposite that at least one outflow opening of the gas generator transverse to its direction of extension.

In one exemplary variant it is provided that the flow-off region comprises a through opening of the carrier already before inflating the gas bag (before igniting the gas generator). Such through opening initially can also be formed only as a relatively small, possibly slot-shaped aperture (i.e. the flow-off region initially is at least partly closed), which then is expanded to a relatively large-surface through opening, when gases flowing out from the gas generator impinge on the flow-off region in a region bordering the aperture. Alternatively, the flow-off region can be formed as an (initially gas-tight) tear region of the carrier (i.e. the flow-off region initially is closed), which upon contact with gas flowing out from the gas generator forms a through opening of the carrier. Furthermore, the flow-off region also can clear an outflow opening in some other way, for example by partial melting. In this case, the flow-off region is fabricated from a plastic material or a fleece mat or comprises such material.

Furthermore, it can be provided that the flow-off region of the carrier for flowing off gases from the gas bag communicates (is connected in a gas-conducting manner) with at least one through opening of the gas bag or the gas bag envelope, so that gas flowing out from the gas generator or present in the interior space of the gas bag can be flown off from the interior space of the gas bag through the at least one through opening of the gas bag and via the flow-off region or through the through opening of the carrier into an external space surrounding the airbag module.

In one exemplary variant, before inflating the gas bag, the flow-off region of the carrier is covered by a material region which can also be formed in multilayer form and can wholly or partly consist of a gas bag material (in particular flexible fabric). During inflation of the gas bag, that material region cooperates with gas emerging from the gas generator such that a through opening is formed at the material region, through which gases present in the gas bag can flow on their way to the flow-off region. Preferably, said material region is a portion of the gas bag or the gas bag envelope arranged before the flow-off region of the carrier. In particular (possibly partly), that material region can include one or more materials which clear a through opening upon contact with gas, in that they are molten or burnt, for example.

If an opened flow-off region and outflow openings (through openings) of the gas bag communicating therewith exist already before inflating the gas bag, a fast flow-off can be effected (e.g. for occupant protection in an ooP case). For the case that the flow-off region or the through openings of the gas bag initially are closed or relatively small and must only be opened or increased by impinging gas, the flow-off effect is delayed correspondingly and above all serves to improve the energy absorption of the person to be protected.

With regard to the aforementioned outflow mechanisms it is important that the same can also be prosecuted as an independent inventive idea as such, independent of a concrete design of the carrier and the remaining components of an airbag module.

In one exemplary embodiment, the carrier furthermore can be formed to protect a plug plugged into the gas generator and connecting the gas generator with an on-board electronic unit, wherein in particular the carrier surrounds that plug in cross-section to protect the plug, and shields the same against mechanical influences.

Furthermore, the problem underlying the invention is solved by a method for manufacturing an airbag module according to the invention. Such method, among other things, provides for folding the gas bag to a package and for fixing the gas bag on the carrier of the airbag module.

In one exemplary design variant of the method, the gas bag initially is folded to a package and thereafter the carrier is introduced into a pocket formed at the gas bag. After introducing the carrier extended flat, the carrier is shaped such that the two possibly parallel, opposed legs of the carrier are obtained, which accommodate the package. It is also conceivable to introduce the carrier already curved in this way into the pocket.

Alternatively, the gas bag initially can be fixed on the carrier extended flat, e.g. by the above-described sewing, bonding or welding (see above), and can then be folded to a package. Subsequently, shaping the carrier is effected such that the two legs of the carrier are located opposite each other and thus form the receptacle for the gas bag (folded to a package) and the gas generator.

### BRIEF DESCRIPTION OF THE DRAWINGS

The illustrated features and advantages of the invention will now be explained in detail with reference to the following description of Figures of exemplary embodiments.

FIG. 1: shows a schematic sectional view of an airbag module according to the invention with a carrier U-shaped in cross-section.

FIG. 2: shows a perspective view of the airbag module shown in FIG. 1.

FIG. 3: shows a schematic sectional view of a modification of the airbag module shown in FIGS. 1 and 2.

FIG. 4: shows a perspective view of an airbag module according to the invention as shown in FIGS. 1 and 2 before folding the gas bag to a package.

FIG. 5: shows a section along line V-V of FIG. 4.

FIG. 6: shows a side view of an airbag module according to the invention.

FIG. 7: shows a perspective view of the airbag module shown in FIG. 6.

FIG. 8: shows a schematic, cut-out and perspective view of an airbag module according to the invention with deployed gas bag.

FIG. 9: shows a schematic, cut-out top view of a further modification of an airbag module according to the invention.

FIG. 10: shows a section along line X-X of FIG. 9.

FIG. 11: shows a modification of the airbag module shown in FIG. 1 with closure strips for the protective sleeve of the airbag module.

FIG. 12: shows a flow-off region of a carrier of an airbag module according to the invention in a schematic, cut-out and perspective view.

FIGS. 13-15: show schematic detailed and sectional views of flow-off regions each with at least one through opening of a gas bag, which is aligned with the flow-off region.

FIG. 16: shows a schematic sectional view of a flow-off region covered by means of a material region.

FIG. 17: shows a schematic sectional view of a mechanically expandable flow-off region.

FIG. 18: shows a schematic sectional view of a flow-off region which in particular can be molten.

FIG. 19: shows a schematic sectional view of a flow-off region in the form of a tear region.

### DETAILED DESCRIPTION OF THE PREFERRED EMBODIMENTS

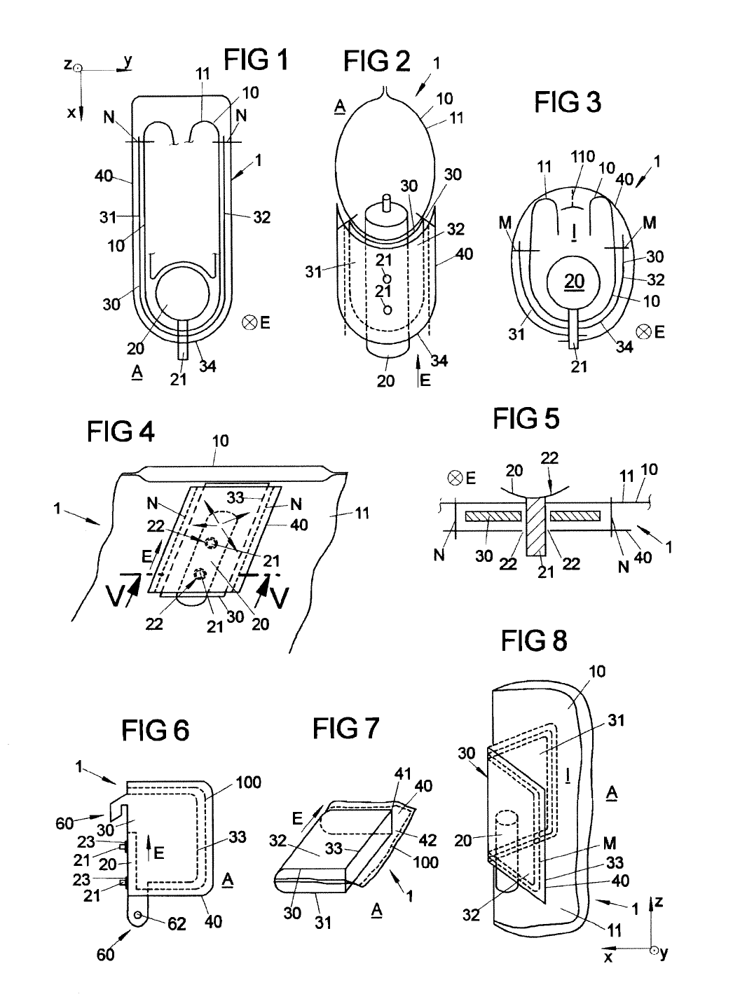

In connection with FIG. 2, FIG. 1 shows an embodiment of an airbag module 1 according to the invention in the form of a side airbag module which is equipped and provided for arrangement at a motor vehicle seat. The airbag module 1 includes a gas bag 10 with a gas bag envelope 11 which surrounds an interior space I of the gas bag 10. The gas bag 10 can be inflated by means of a gas generator 20 in the form of a tubular gas generator, which is arranged in the interior space I of the gas bag 10 and extended along a direction of extension E, with gas provided by the gas generator 20, wherein that gas generator 20—based on a condition of the airbag module 1 properly mounted in the motor vehicle—extends along a backrest of the motor vehicle seat or substantially along the vertical vehicle axis z. In the inflated condition, the gas bag 10 extends along a lateral motor vehicle body region (i.e. along the x-z-plane), in order to protect e.g. the pelvis, the thorax and/or the head of a person. For this purpose, the airbag module 1 preferably is equipped and provided for arrangement at a backrest of a motor vehicle seat.

The airbag module 1 includes a flat carrier 30 which carries the gas generator 20 and the gas bag 10, wherein said carrier 30 is curved such that in a cross-sectional plane vertical to the direction of extension E it has a U-shaped cross-section or, in other words, the carrier 30 has two legs 31 and 32 which are located opposite each other transverse to the direction of extension E, namely along the transverse axis y of the vehicle, and each extend along the x-z-plane which is defined by the longitudinal axis x of the vehicle and the vertical vehicle axis z.

For the protection of the gas bag 10, an outermost protective sleeve 40 furthermore is provided, which preferably closely surrounds the carrier 30 and the components of the airbag module 1 connected thereto. The protective sleeve 40 in particular is a flexible protective film.

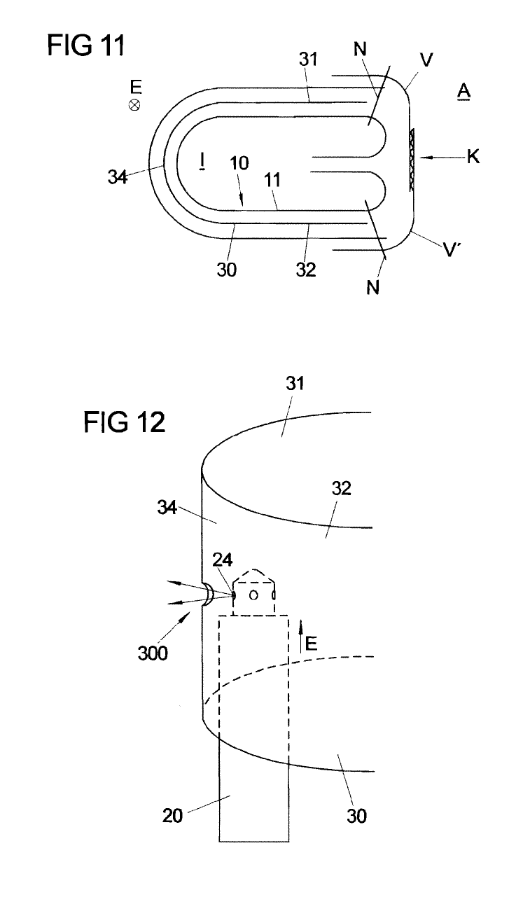

According to FIG. 11, the protective sleeve 40 for example can be closed by closure strips V, V′ before inflating the gas bag 10, which for example can each be fixed on the protective sleeve 40 and possibly the gas bag envelope 11 by means of seams N. These closure strips V, V′ are connected with each other along their respective edges, in order to close the protective sleeve 40 before inflation. The connection can be a weld or a bond and possibly can represent a pre-weakened connection. Alternatively, the two closure strips V, V′ also can form a hook-and-loop fastener K, in that a corresponding hook region (or the like) is provided on one of the closure strips V and an associated eyelet region (or the like) is provided on the other closure strip V′. By means of the seams N, a pocket 50 for receiving the carrier 30 can also be created between the protective sleeve 40 and the gas bag envelope 11 (see below).

The two legs 31, 32 in particular are integrally molded to each other, so that the carrier 30 has a rounded edge 34 extended along the direction of extension E as well as open covering surfaces towards the vehicle front, the roof liner and the vehicle floor, which each are closed by the protective sleeve 40 (before inflating the gas bag 10).

In this way, the carrier 30 or its legs 31, 32 on the one hand forms a receptacle for the gas generator 20 and the gas bag 10 folded to a package and on the other hand an ejection channel, in that during deployment the two legs 31, 32 guide the gas bag 10 or its gas bag envelope 11 along the longitudinal axis x of the vehicle or along the vertical vehicle axis z. For this purpose, the two legs 31, 32 preferably significantly protrude beyond the gas generator 10 at least along the longitudinal axis x of the vehicle.

In the inflated condition, however, the gas bag 10 protrudes from the receptacle formed by the carrier 30 along the longitudinal axis x of the vehicle and along the vertical vehicle axis z (cf. FIG. 8) and forms a side protection for a person to be protected.

For fixing the gas generator 10 on the carrier 30 for example two bolts 21 protrude from the gas generator 10, which each are guided through aligned through holes 22 of the carrier 30, the gas bag envelope 11 and the protective sleeve 40 of the carrier 30 and are screwed to the carrier 30 by means of nuts 23.

The corresponding through holes 22 of the carrier are formed at the edge 34 of the carrier 30, so that the gas generator 10 is arranged along the edge 34 of the carrier 30 between the two legs 31, 32 of the carrier 30.

In connection with FIG. 5, FIG. 4 shows the fixation of the gas bag 10 or the gas bag envelope 11 of the airbag module 1 on the carrier 30 for an airbag module 1 according to FIGS. 1 to 2. For this purpose, a pocket 50 is formed on an outwardly facing side of the gas bag envelope 11, in that for example the outer protective sleeve 40 of the airbag module 1 is fixed on the gas bag envelope 11 by means of parallel seams N, which are extended along the direction of extension E, so that the gas bag envelope 11 and the region of the protective sleeve 40 fixed thereon form a pocket 50 into which the carrier 30 can be introduced in a condition extended flat along the direction of extension E, namely preferably after folding up the gas bag envelope 11 to a package, so that the through holes 22 of the carrier are aligned with the through holes 22 of the gas bag envelope and the through holes 22 of the protective sleeve 40. Then, the gas generator 10 can be arranged in the interior space I of the gas bag 10, wherein its bolts 21 are guided through the through holes 22 lying one above the other, so that the gas generator 10 can be screwed to the carrier 30. After introducing the carrier 30 into the pocket 50, the same can be brought into the condition as shown in FIG. 1 or 2, for example by bending the carrier 30 along the edge 34. As a result, the gas bag 10 folded to a package is accommodated between the legs 31, 32 of the carrier 30.

FIG. 3 shows a modification of the airbag module 1 shown in FIGS. 1 and 2, in which in contrast to FIGS. 1 and 2 the carrier 30 is connected with the gas bag envelope 11 via a circumferential outer edge 33 of the carrier 30, namely by means of a seam M which extends along said edge 33. Such type of connection between carrier 30 and gas bag envelope 11 of the gas bag 10 can also be present in the airbag module of FIG. 8, which shows the deployed gas bag 10 and the opened legs 31, 32 of the carrier 30, wherein the gas bag envelope 11 in addition can have a recess (cut-out) in the region of the carrier 30, which is covered or closed by means of the carrier 30. For this purpose, the carrier 30 possibly protrudes beyond a circumferential edge of said recess with its circumferential edge 33 and is fixed on the gas bag envelope 11 via a seam M along the edge 33 (bonded connections or welded connections also are conceivable). The carrier 30 as shown in FIG. 8 can of course also be fixed on the gas bag 10 in the other ways described above (e.g. via a pocket 50). Furthermore, FIG. 3 shows a tear seam 110 which serves to preserve the convolution of the gas bag 10 before inflating the same. For this purpose, the possibly circumferential tear seam 110 connects opposed regions of the gas bag envelope 11, so that the individual convolutions of the gas bag envelope 11 can be fixed. Such tear seams 110 can of course also be provided in all other airbag modules 1 according to the invention.

The protruding connection M between the carrier 30 and the gas bag envelope 11 preferably is designed in a condition of the carrier 30 extended flat. Thereafter, the gas bag 10 and the gas bag envelope 11 is folded to a package and then the one leg 31 is bent onto the other leg 32 of the carrier 30, so that its form U-shaped in cross-section is obtained.

In connection with FIG. 7, FIG. 6 shows an airbag module 1 according to the invention before inflating the gas bag 10. FIG. 8 shows the airbag module after inflating the gas bag 10. According to FIG. 6, an airbag module 1 according to the invention in principle can provide fastening means 60 at the carrier 30, which can be equipped and provided for fixing the airbag module 1 on the motor vehicle, in particular on a backrest frame of a motor vehicle seat of the motor vehicle.

For this purpose, the fastening means 60 for example comprises a hook 61 and a through hole 62 in a tab of the carrier 30, wherein both that tab and the hook 61 in particular can be integrally molded to the carrier 30 and can protrude from the protective sleeve 40. Other fastening elements are of course also conceivable. Via the fastening means 60, the airbag module 1 for example can be hooked into a backrest frame of the vehicle seat and be end-fixed there by means of the fastening means. Hooking in can be effected for example by means of the hook 61, wherein end-fixing the airbag module 1 at the backrest frame for example is possible via the through hole 62, e.g. in that a bolt is guided through the through hole 62 and screwed to the backrest frame, e.g. by means of a nut.

According to FIG. 7, the protective sleeve 40 itself furthermore can include a predetermined breaking point 100, for example in the form of a bonded connection or welded connection of two protective sleeve parts 41, 42, along which the protective sleeve 40 will burst during inflation of the gas bag 10, in order to release the gas bag 10. The predetermined breaking point 100 also can be some other weak point of the material (e.g. perforation or indentation etc.). A hook-and-loop fastener or a tear seam likewise can serve for closing the protective sleeve (see above).

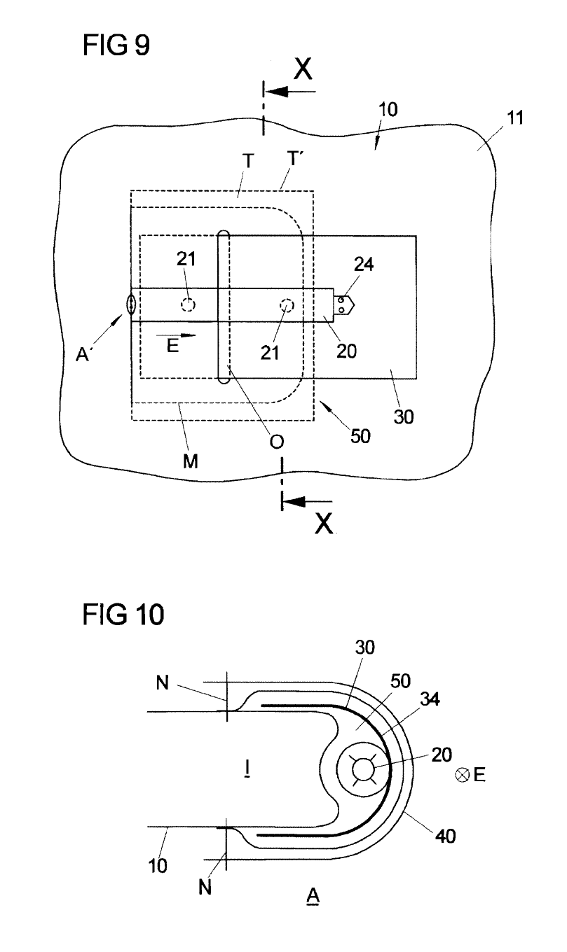

With reference to a schematic top view, FIG. 9 in connection with FIG. 10 shows a further embodiment of an airbag module 1 according to the invention, in which the pocket 50 for receiving the carrier 30 (and the gas generator 20 mounted thereon) is formed by a flexible material layer T which is fixed on the gas bag envelope 11 of the gas bag 10 from the (future) interior space I of the gas bag 10 or from the exterior space A, in particular by means of a seam M which can extend along an outer circumferential edge T′ of the material layer T. That connection M can, however, also be interrupted, so that from that interruption for example an end portion of the gas generator 20 can protrude from the pocket 50, which includes a connecting region A′, e.g. for a plug by which the gas generator 20 is connectable with an on-board electronic control unit for actuating the gas generator 20. The pocket 50 for the carrier 30, which is formed as described above, in particular includes a through opening O through which the carrier 30 can be introduced into the pocket 50. This through opening O can be provided at the gas bag envelope 11 (gas bag 10) or said material layer T. For the case that the through opening O is provided at the gas bag envelope 11, the material layer T of course covers that through opening O of the gas bag envelope 11. The pocket 50 can be formed such that the carrier 30 can completely be arranged in the pocket 50, or also such that the carrier 30 can protrude from the pocket 50 on one or possibly on two opposite sides thereof. In this case, no connection (seam M) between the material layer T and the gas bag envelope 11 of the gas bag 10 is provided on those sides of the pocket 50.

In all airbag modules 1 according to the invention, a flow-off region 300 provided on the carrier 3 can be present, via which gas can be flown off from the interior space I of the gas bag 10 surrounding the gas bag envelope 11 of the gas bag 10, i.e. be discharged into an exterior space A surrounding the gas bag 10.

According to FIG. 12, the gas generator 20 preferably is arranged along the rounded edge 34 of the carrier 30, which—like the gas generator 20—extends along the direction of extension E, so that the two legs 31, 32 of the carrier 30, which are connected with each other (in particular integrally molded to each other) via the edge 34, extend on both sides of the gas generator 20 and in so far also can perform a heat protection function, i.e. can shield gas bag parts from gases flowing out of the gas generator 20. For flowing off gas, the gas generator 20 includes at least one outflow opening 24 which preferably is located opposite a region of the edge 34 or the carrier 30 formed as flow-off region 300.

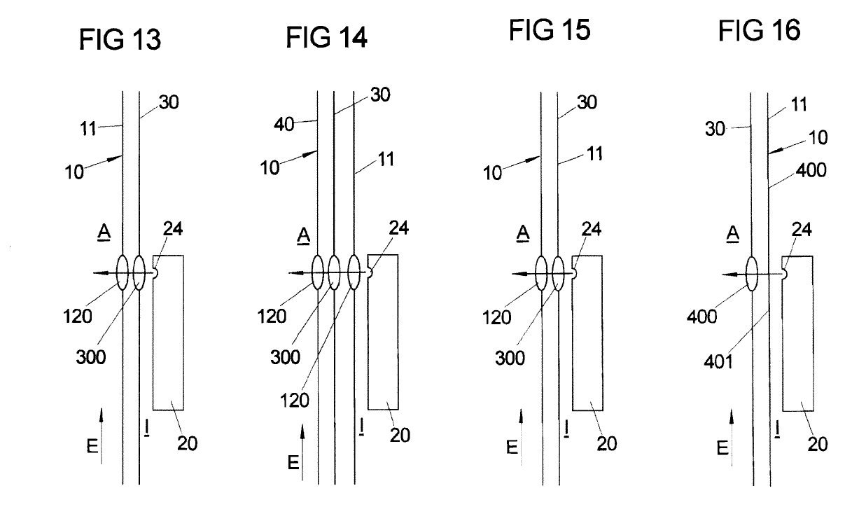

In the exemplary embodiments of FIGS. 12 to 16, the flow-off region 300 of the carrier 30 each is formed as a permanent through hole 300 through which gas emerging from the gas generator 20 can flow through the carrier 30. According to FIG. 13, at least one through opening 120 is formed in the gas bag envelope 11, which is aligned with the through opening 300 of the carrier 30, wherein in the exemplary embodiment of FIG. 13 the carrier 30 is arranged in the interior space I of the gas bag 20, so that the gas bag envelope 11 with its through opening 120 extends before the carrier 30. Through the permanently open through openings 120, 300 aligned with each other, gas present in the interior space I of the gas bag 10 or gas flowing out from the gas generator 20 through the at least one outflow opening 24 can directly be discharged (flown off) into an exterior space A surrounding the gas bag 10.

In the modification shown in FIG. 15, in contrast to FIG. 13, the gas bag envelope 11 extends in the region of the gas generator 20 between the carrier 30 and the gas generator 20.

In the modification shown in FIG. 14, the carrier 30 extends between two layers 11, 40 (e.g. gas bag envelope 11 and protective sleeve 40) of the airbag module 1, so that on those layers 11, 40 two permanent through openings 120 correspondingly are provided, which are aligned with the through opening 300 of the carrier 30.

FIG. 16 shows a modification of the configuration shown in FIG. 15, in which in contrast to FIG. 15 no permanent through opening 120 is formed at the gas bag envelope 11, but the flow-off region 300 is covered by a material region 400 which preferably is a continuous portion of the gas bag 10, i.e. of the gas bag envelope 11. This material region 400 is burnt up by gas emerging from the gas generator 20, so that a through opening 401 (not shown) is formed at that material region, through which gas then can emerge from the gas bag 10. In the region of the future through opening 401, the gas bag 10 possibly includes one or more materials which correspondingly can suitably cooperate with the gas flowing out from the gas generator 20, in order to generate said through opening 401.

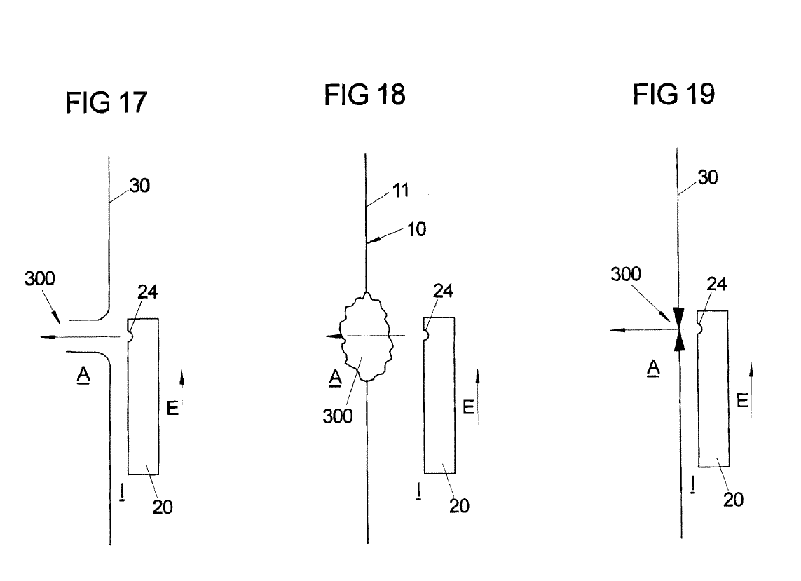

Instead of a flow-off region as shown in FIG. 12, which is formed as permanent through opening 300 of the carrier 30, the flow-off region of FIG. 17 initially can be formed as a relatively small aperture of the carrier 30, which only is expanded by contact with gas flowing out from the gas generator 20 through the at least one outflow opening 24 and thus forms a larger through opening 300. Alternatively, the flow-off region 300 as shown in FIG. 19 initially can also be closed completely. In this case, the flow-off region is formed by a tear region 300 of the carrier 30, which only is opened by contact with gas flowing out from the gas generator 20, e.g. mechanically. Alternatively, in the flow-off region 300 as shown in FIG. 18 the carrier 30 can also be fabricated from a material (e.g. plastics) which is molten or burnt upon contact with gas flowing out from the gas generator 20, so that a through opening 300 is formed through which gas can emerge from the interior space I of the gas bag 10.

The priority application, German Patent Application Number 10 2009 024 142.6, filed on Jun. 4, 2009 is incorporated by reference herein.

1. An airbag module, in particular side airbag module, for a motor vehicle, comprising:
a gas bag inflatable with gas to protect a person,
a gas generator longitudinally extending along a direction of extension for releasing the gas required for inflating the gas bag, and
a flat carrier for carrying the gas bag and the gas generator, wherein the carrier includes two legs which are connected with each other along the direction of extension and are located opposite each other transverse to the direction of extension, so that the carrier forms a receptacle open on three sides for the gas generator and the gas bag,
wherein the carrier comprises a flow-off region, through which gas emerging from at least one outflow opening of the gas generator can be flown off into an exterior space surrounding the airbag module.

2. The airbag module according to claim 1, wherein the two legs are integrally molded to each other along the direction of extension.

3. The airbag module according to claim 1, further comprising a flexible protective sleeve of the airbag module, which at least partly surrounds the carrier, the gas generator and the gas bag, wherein in particular the protective sleeve is formed by at least two protective sleeve parts which for forming the protective sleeve are connected with each other, in particular welded or bonded to each other or connected with each other via a hook-and-loop fastener.

4. The airbag module according to claim 3, wherein the carrier is introduced into a pocket formed on the gas bag for fixing the gas bag on the carrier.

5. The airbag module according to claim 4, wherein the protective sleeve is connected with the gas bag such that the protective sleeve together with the gas bag forms said pocket for the carrier.

6. The airbag module according to claim 4, wherein for forming the pocket a flexible material layer, in particular of a gas bag material, is fixed on the gas bag, wherein in particular on that material layer or on the gas bag a through opening is provided, through which the carrier can be introduced into the pocket.

7. The airbag module according to claim 1, wherein the gas bag defines an interior space which can be filled with gas for inflating the gas bag, wherein in particular the carrier is arranged in the interior space of the gas bag.

8. The airbag module according to claim 1, wherein the gas bag is folded to a package arranged between the legs.

9. The airbag module according to claim 1, wherein the flow-off region is formed as a through opening of the carrier.

10. The airbag module according to claim 1, wherein on contact with gas flowing out from the gas generator the flow-off region forms a through opening of the carrier.

11. The airbag module according to claim 9, wherein the through opening of the carrier expands when gas flowing out from the gas generator flows through said opening.

12. The airbag module according to claim 1, wherein the gas bag includes at least one through opening communicating with the flow-off region of the carrier, so that gas flowing out from the gas generator can be flown off through the at least one through opening of the gas bag via the flow-off region of the carrier into an exterior space surrounding the airbag module.

13. The airbag module according to claim 1, wherein before inflating the gas bag the flow-off region is covered by a material region of a gas bag material, wherein in particular the material region is formed by a portion of the gas bag.

14. The airbag module according to claim 13, wherein during inflation of the gas bag the material region cooperates with gas flowing out from the gas generator such that a through opening is formed at the material region.

15. The airbag module according to claim 10, wherein the through opening of the carrier expands when gas flowing out from the gas generator flows through said opening.
